(19) United States
(12) Patent Application Publication
(10) Pub. No.: US 2003/0137586 A1
(43) Pub. Date: Jul. 24, 2003

(54) Vehicle video switching system and method

(75) Inventor: Mark A. Lewellen, Ozark, MO (US)

Correspondence Address: MARTIN & ASSOCIATES, LLC, P O BOX 548, CARTHAGE, MO, 64836-0548, US

(73) Assignee: Infinite Innovations, Inc., Springfield, MO

(21) Appl. No.: 10/054,185

(22) Filed: Jan. 22, 2002

(51) Int. Cl. H04N 7/18

(52) U.S. Cl. 348/148

(57) ABSTRACT

A vehicle video switcher receives inputs from multiple video cameras on a vehicle, and independently routes any of these video inputs to multiple video monitors in the vehicle. A front video monitor is within the view of the driver of the vehicle. When the driver activates the left turn signal, the view from the left side video camera is displayed on the front video monitor. When the driver activates the right turn signal, the view from the right side video camera is displayed on the front video monitor. When the driver puts the vehicle in reverse, thereby activating the backup light, the view from the rear video camera is displayed on the front video monitor. The driver may select the default view for the front video monitor by pressing on a button or by using a hand-held remote control. Graphical view indicators superimposed on the displayed image indicate which view is currently being displayed. A remote video monitor is also provided in the vehicle in a different location, such as in the rear living area of a recreational vehicle. A passenger can direct different video camera views to be displayed on the remote video monitor using a user interface, such as push-buttons on the monitor or handheld remote control, independent of the video image displayed on the front video monitor. In addition, the default view for the remote video monitor may be selected independently from the default view of the front video monitor using a user interface.

### BACKGROUND OF THE INVENTION

1. Technical Field

This invention generally relates to vehicles, and more particularly relates to the display of video images from video cameras mounted on a vehicle.

2. Background Art

When driving a vehicle, it is desirable to have a clear view in all directions. In a large vehicle, such as a recreational vehicle or a tractor-trailer, the driver is so far removed from some parts of the vehicle that it is difficult or impossible for the driver to have a clear view of all sides of the vehicle. Mirror systems are available that allow the driver to see the front and back of the vehicle. These systems, however, do not work well for viewing behind the vehicle because the rear of the vehicle is so far removed from the driver's cab that the distance makes the use of mirrors impractical.

To alleviate the problem of viewing all sides of a large vehicle, the prior art has introduced several systems that include video cameras mounted in different locations on the vehicle, with a video monitor mounted within the driver's view (typically on the dashboard) so the driver can view all sides of the vehicle. One example of such a system 100 is shown in FIG. 1. Vehicle 110 includes a front video camera 120, a left side video camera 130, a right side video camera 140, and a rear video camera 150. Providing these video cameras on vehicle 110 along with a monitor within the view of the driver allows the driver to see views from all these cameras from the driver's seat, thereby enhancing the safety of operating the vehicle 110.

Some known vehicle video systems automatically change the view on the monitor according to signals received from the vehicle. These systems display the left side camera view when the left turn signal is activated, display the right side camera view when the right turn signal is activated, and display the rear camera view when the backup light on the vehicle is activated. Examples of such systems are shown in U.S. Pat. No. 5,530,421 issued to Marshall et al. on Jun. 25, 1996; U.S. Pat. No. 5,574,443 issued to Hsieh on Nov. 12, 1996; and U.S. Pat. No. 5,680,123 issued to Lee on Oct. 21, 1997. One problem not addressed in the prior art is identifying to the driver which view is currently being displayed. The prior art also does not teach the display of different video views simultaneously on separate video monitors in the vehicle. Furthermore, the prior art does not teach controlling the view on one or more video monitors using a wireless remote control. In addition, the prior art does not allow the default view of a monitor to be changed by the user. These deficiencies in the prior art are overcome by the preferred embodiments of the present invention, discussed in detail below.

### DISCLOSURE OF INVENTION

According to the preferred embodiments, a vehicle video switcher receives inputs from multiple video cameras on a vehicle, and independently routes any of these video inputs to multiple video monitors in the vehicle. A front video monitor is within the view of the driver of the vehicle. When the driver activates the left turn signal, the view from the left side video camera is displayed on the front video monitor. When the driver activates the right turn signal, the view from the right side video camera is displayed on the front video monitor. When the driver puts the vehicle in reverse, thereby activating the backup light, the view from the rear video camera is displayed on the front video monitor. The driver may select the default view for the front video monitor by pressing on a button or by using a hand-held remote control. Graphical view indicators superimposed on the displayed image indicate which view is currently being displayed. A remote video monitor is also provided in the vehicle in a different location, such as in the rear living area of a recreational vehicle. A passenger can direct different video camera views to be displayed on the remote video monitor using a user interface, such as push-buttons on the monitor or handheld remote control, independent of the video image displayed on the front video monitor. In addition, the default view for the remote video monitor may be selected independently from the default view of the front video monitor using a user interface.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a top view of a vehicle that includes video cameras for viewing areas surrounding the vehicle;

FIG. 2 is a perspective view of a windshield and dashboard of a vehicle that includes a front video monitor in accordance with the preferred embodiments;

FIG. 3 is a sample view of a video monitor in accordance with the preferred embodiments that includes graphical view indicators that show which camera view is being displayed on the video monitor;

FIG. 4 is a sample view of a video monitor in accordance with the preferred embodiments that includes a graphical view indicator that indicates that the view of the rear camera is currently being displayed;

FIG. 5 is sample view of a video monitor in accordance with the preferred embodiments that includes a text indicator that indicates that the view of the rear camera is currently being displayed;

FIG. 6 is a schematic block diagram of the video switch system in accordance with the preferred embodiments;

FIG. 7 is a flow diagram of a method for changing the view on a video monitor based on vehicle inputs in accordance with the preferred embodiments; and

FIG. 8 is a flow diagram of a method for a user to change the default view displayed on a video monitor in accordance with the preferred embodiments.

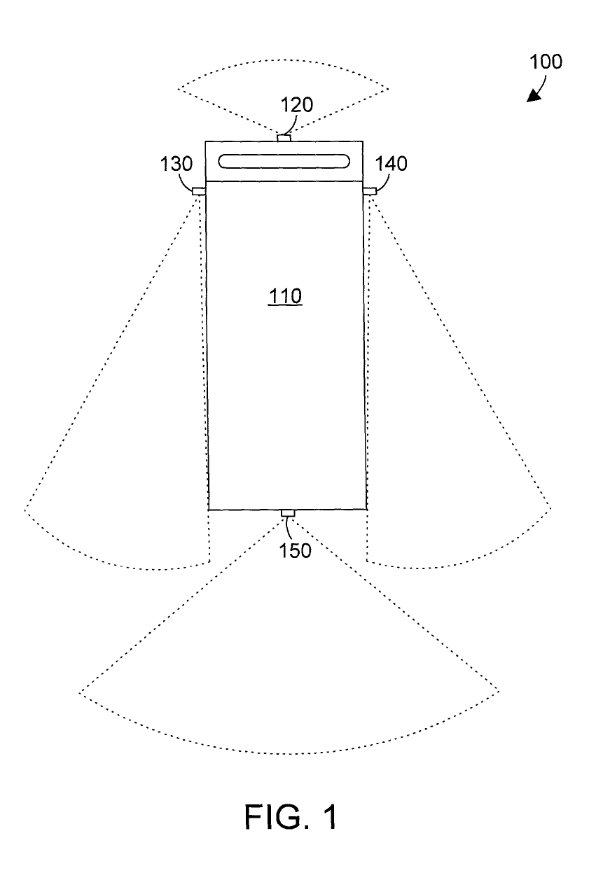

### BEST MODE FOR CARRYING OUT THE INVENTION

The preferred embodiments provide an in-vehicle video switching system that can independently route different video signals to the multiple monitors, that provides a graphical indication of which view is being displayed on a video monitor, and that allows the user to set the default view that is displayed when no control signals on the vehicle interface are active.

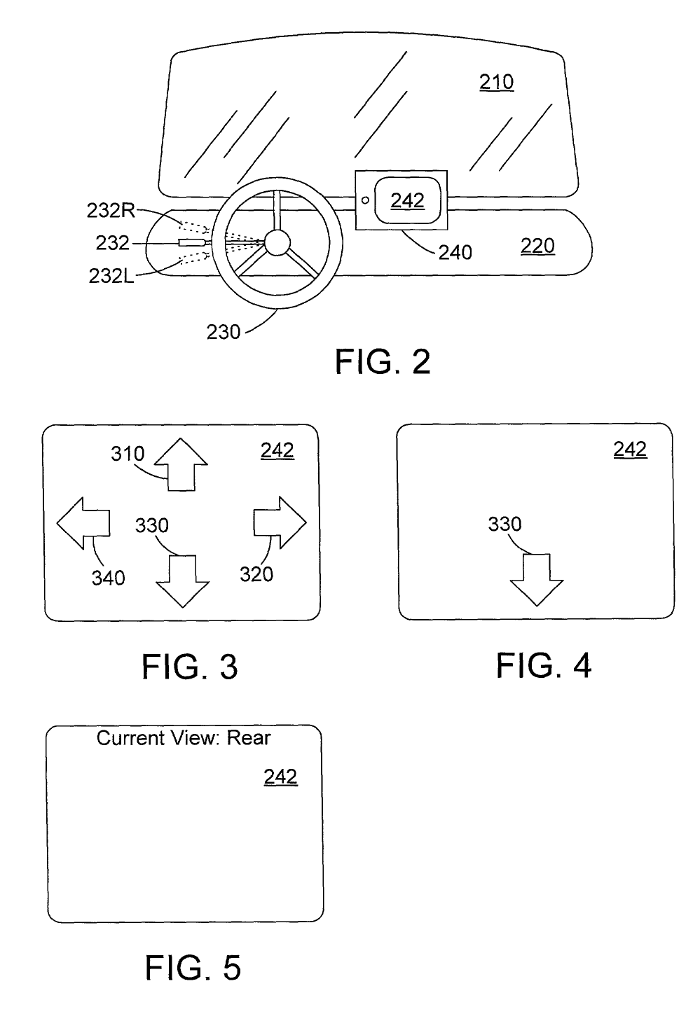

Referring to FIG. 2, one example of a vehicle dashboard area is shown that includes a windshield 210, a dashboard 220, a steering wheel 230, and a video monitor 240. On the left side of the steering column is a turn signal lever 232 that is normally in a middle position (shown in solid lines) when no turn signal is activated, and that is in an upper position 232R to activate the right turn signal, and is in a lower position 232L to activate the left turn signal. It is known in the art to switch between camera views based on control signals received from the vehicle. Thus, when the left turn signal is activated by placing the turn signal lever 232 in position 232L, the view from the left video camera 130 is displayed on monitor 240. When the right turn signal is activated by placing the turn signal lever 232 in position 232R, the view from the right video camera 140 is displayed on monitor 240. When the vehicle is put in reverse, the view from the rear video camera 150 is displayed on monitor 240. Of course, the prior art video switching system necessarily includes a vehicle interface that communicates the vehicle's control signals (e.g., left turn signal, right turn signal, reverse) to the video switching system. In this manner, several different views may be automatically displayed to the user at different times depending on the control signals present on the vehicle interface.

One deficiency in the prior art is that there is no indication on the video monitor of which view is currently being displayed. This deficiency is overcome by the video switching system of the preferred embodiments displaying a graphical indicator of which camera view is currently being displayed. Note that the graphical view indicator may be any suitable indicator, including any graphics, text, lines, etc. that communicate to the driver which camera view is currently being displayed. Referring to FIG. 3, we assume that the video switching system of the preferred embodiments can display one of four graphical view indicators, shown by way of example in FIG. 3 as arrows, within the viewing window 242 of the video monitor 240. The up arrow 310 indicates that the view from the front video camera 120 is currently being displayed within the viewing window 242. The right arrow 320 indicates that the view from the right video camera 140 is currently being displayed within the viewing window 242. The down arrow 330 indicates that the view from the rear video camera 150 is currently being displayed within the viewing window 242. The left arrow 340 indicates that the view from the left video camera 130 is currently being displayed within the viewing window 242. These arrows are preferably colored outlines that are superimposed upon the image being displayed so that they are readily noticeable, yet minimally interfere with the image being displayed. Note that only one of these view indicators 310, 320, 330 and 340 will be displayed at any given time. Thus, when the vehicle is put in reverse, the view from the rear camera 150 is displayed in the viewing window 242, and the view indicator 330 that indicates the rear view is superimposed upon the image, as shown in FIG. 4. Another suitable type of view indicator is text that states which camera view is currently being displayed. An example of a text view indicator is shown in FIG. 5, where the current view is said to be “Rear”, meaning that the view from the rear camera 150 is currently being viewed in the viewing window 242. The arrow of FIG. 4 and text of FIG. 4 are presented herein as suitable examples of graphical view indicators that indicate which view is being displayed. Note that the term “graphical view indicator” does not mandate the use of graphics. Text may also be used, as shown in FIG. 5. The term “graphical view indicator” is used herein in its broadest sense to mean any visual indication to the user that is superimposed upon the video image that indicates which camera view is currently being displayed. Note that the actual image from a video camera that is being displayed within the viewing window 242 in FIGS. 3-5 is not shown for the purpose of clarity. The reader will readily understand that the graphical view indicator is superimposed over the image from the selected video camera.

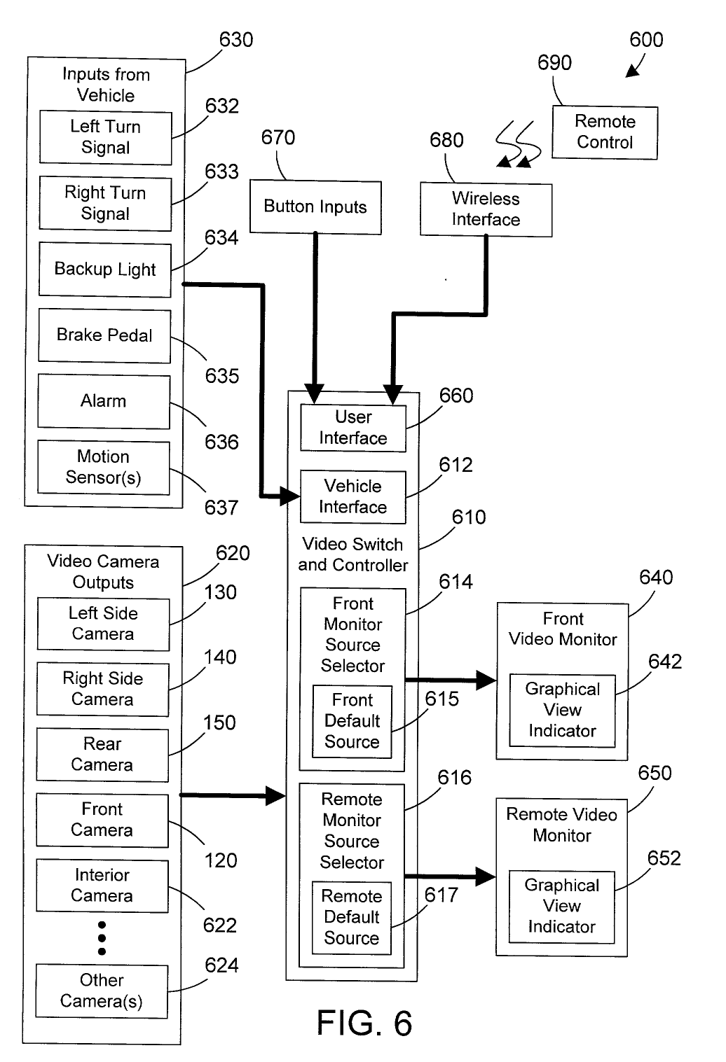

Referring to FIG. 6, a system 600 in accordance with the preferred embodiments includes a video switch and controller 610 that is coupled to multiple video camera outputs 620. Video camera outputs 620 may include outputs from a left side camera 130, a right side camera 140, a rear camera 150, a front camera 120, an interior camera 622, or any other video camera (or cameras) 624 that may be mounted in or on the vehicle. Video switch and controller 610 also includes a vehicle interface 612 that is coupled to inputs 630 from the vehicle. Some suitable vehicle inputs 630 include: left turn signal 632, right turn signal 633, backup light 634, brake pedal 635, alarm 636, and motion sensor(s) 637. Of course, other inputs may also be received from the vehicle that determine which view is displayed on a video monitor.

Video switch and controller 610 is coupled to one or more video monitors. In the preferred embodiments, video switch and controller 610 is coupled to a front video monitor 640 and to a remote video monitor 650. Front video monitor 640 includes one or more graphical view indicators 642 that visually indicate to an observer which video camera output 620 is currently being displayed on the front video monitor 640. Similarly, remote video monitor 650 includes one or more graphical view indicators 652 that indicate which video camera output 620 is currently being displayed on the remote video monitor 650.

The video switch and controller 610 includes a front monitor source selector 614 that selects one of the video camera outputs 620 to display on the front video monitor 640. When the left turn signal 632 is active, the front monitor source selector 614 routes the output of the left side camera 130 to the front video monitor 640, and also displays a graphical view indicator 642 that indicates that the left camera view is currently being displayed. When the right turn signal 633 is active, the front monitor source selector 614 routes the output of the right side camera 140 to the front video monitor 640, and also displays a graphical view indicator 642 that indicates that the right camera view is currently being displayed. When the backup light 634 is active, the front monitor source selector 614 routes the output of the rear camera 150 to the front video monitor 640, and also displays a graphical view indicator 642 that indicates that the rear camera view is currently being displayed. In similar fashion, when the brake pedal is pressed, the front monitor source selector 614 routes the output of the rear camera 150 to the front video monitor 640, and also displays a graphical view indicator 642 that indicates that the rear camera view is currently being displayed. Similarly, when an alarm signal 636 is active, the video output of a particular camera (such as the right side camera 140 that views the entry door of a recreational vehicle) may be displayed on the front video monitor 640. When the vehicle is not moving, one or more motion sensors 637 may cause the view of a video camera that is directed at the area where motion was detected to be displayed.

The front monitor selector 614 includes a front default source 615, which is a specification of which video camera output 620 to display on the front video monitor 640 when no control signals are active on the vehicle interface 612. In the preferred embodiments, the front default source 615 is set at the factory to display a particular video camera output 620 on the front video monitor 640, but can then be changed by the user according to the user's preference. The ability for a user to change the default view is a significant advantage over the prior art.

Video switch and controller 610 further includes a remote monitor source selector 616, which includes a remote default source 617 that specifies which video camera output 620 to display on the remote video monitor 650 when no control signals are active on the vehicle interface 612. In the preferred embodiments, the remote default source 617 is set at the factory to display a particular video camera output 620 on the remote video monitor 650, but can then be changed by the user according to the user's preference. Note that remote monitor source selector 616 operates independently from the front monitor source selector 614. This allows the remote video monitor 650 to not only display different views than the front video monitor 640, but to also operate in a different manner. For example, the remote monitor source selector 616 may not change the view when the left turn signal 632 or right turn signal 633 are active. In addition, the front default source 615 and remote default source 617 may specify a timed sequence of camera views rather than a single camera view. In other words, the default view when no vehicle inputs 630 are active may be to display each camera view in round-robin format for one or two seconds for each view.

Video switch and controller 610 includes a user interface 660 that is coupled to one or more devices that allow a user to interact with the video switch and controller 610. In FIG. 6, examples of suitable user devices include button inputs 670 and a wireless interface 680. Button inputs 670 may include push-buttons on the front video monitor 640, push-buttons on the remote video monitor 650, and push-buttons located on the dashboard or elsewhere for controlling the function of the video switch and controller 610. Wireless interface 680 allows a user to use a wireless remote control 690 to interact with the video switch and controller 610. Note that the user interface 660 may display setup information to a user on the front video monitor 640, on the remote video monitor 650, or on both. In this manner a user can use the button inputs 670 or remote control 690 to display a menu of options from which the user may select the front default source 615, the rear default source 617, and various operational features of the front monitor source selector 614 and remote monitor source selector 616.

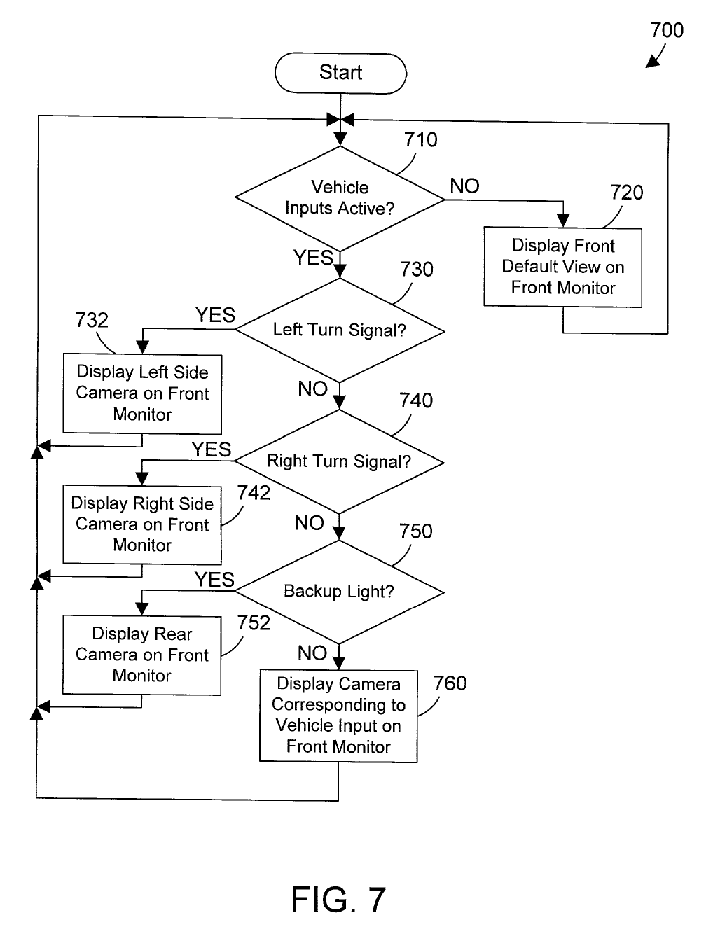

Various methods are within the scope of the preferred embodiments. One such method 700 is shown in FIG. 7, which is a method for displaying the outputs of a plurality of video cameras on a vehicle to a front video monitor (in the view of the driver) according to vehicle inputs that may be active on a vehicle interface. First, method 700 determines if any vehicle input is active (step 710). If not (step 710=NO), the front default view is displayed on the front monitor (step 720). Note that the default view is determined by the front default source 615 that is preferably factory-set to a default but can be overridden by a user via the user interface 660. If a vehicle input is active (step 710=YES), method 700 then determines if the active vehicle input is the left turn signal (step 730). If so (step 730=YES), the left side camera view is displayed in the front video monitor (step 732). If not (step 730=NO), method 700 then determines if the active vehicle input is the right turn signal (step 740). If so (step 740=YES), the right side camera view is displayed on the front video monitor (step 742). If not (step 740=NO), method 700 then determines if the active vehicle input is the backup light that indicates the vehicle is in reverse (step 750). If so (step 750=YES), the rear camera view is displayed on the front video monitor (step 752). If not (step 750=NO), method 700 displays a camera corresponding to the vehicle input on the front monitor (step 760). Note that step 760 applies to all other vehicle control signals other than the left and right turn signals and the backup light, such as the brake pedal, alarm, and motion sensors.

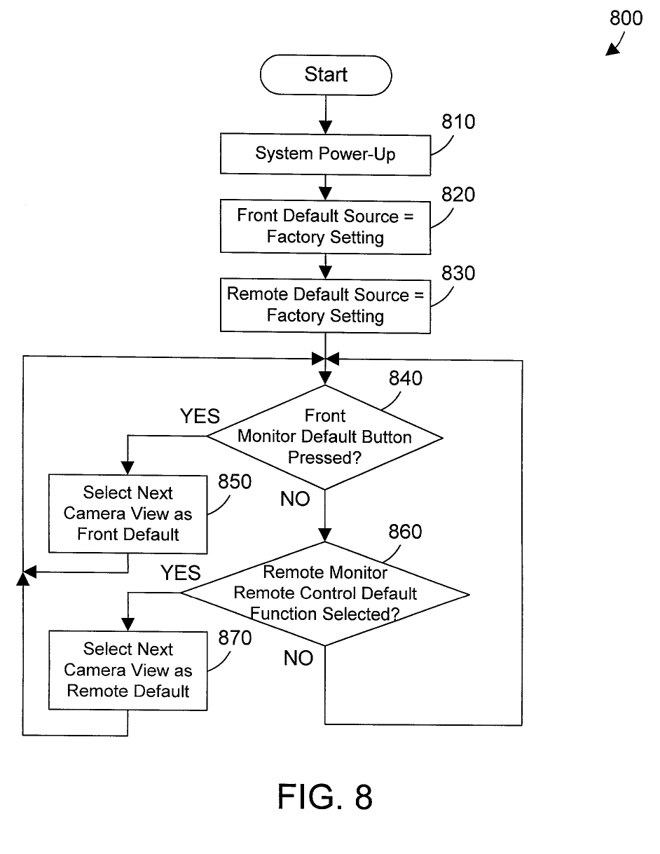

Another method in accordance with the preferred embodiments is the ability for a user to change the default view, which is the view that is displayed when no vehicle control inputs are active. One suitable example of such a method is shown as method 800 in FIG. 8. When the system is first powered-up (step 810), the front default source is set to its factory setting (step 820), and the remote default source is set to its factory setting (step 830). Now a user may change these defaults using a user interface. For the example in FIG. 8, we assume that the user uses buttons on the front video monitor to change the default view for the front monitor. Step 840 determines whether the front default button is pressed (step 840). If so (step 840=YES), the next camera view is selected as the front default (step 850). By “next camera view”, we mean the view of the next camera in an arbitrarily-determined round-robin rotation from one camera view to the next. Step 850 determines whether the remote monitor remote control default function is selected (step 860). This function may be selected using a push-button on the remote monitor, or using the wireless remote control. If the remote control default function for the remote monitor is selected (step 860=YES), the next camera view is selected as the default view for the remote video monitor (step 870). Method 800 thus allows a user to change the default view that is displayed on both front and remote monitors when no vehicle control inputs are active. Note that the “default view”, as stated above, may be not just a view from a single camera, but can also be a timed sequence of views from two or more selected cameras.

The apparatus and method of the preferred embodiments allow great flexibility in displaying views from video cameras both to the driver and to another occupant, such as a passenger in a bus or a person in the rear portion of a recreational vehicle. Using the preferred embodiments, the default view for the front video monitor may be set by the driver to be the front camera view, while the default view for the remote video monitor may be set to be a timed sequence of each camera view: front, left side, rear, right side, then repeating the sequence. Control signals from the vehicle may cause the view on the front video monitor to change according to the signal. Thus, when the left turn signal is activated, the view from the left video camera is displayed on the front video monitor. When the right turn signal is activated, the view from the right video camera is displayed on the front video monitor. When the backup light is activated, indicating the vehicle is in reverse, the view from the rear video camera is displayed on the front video monitor. When the brake pedal is pressed, the view from the rear video camera is displayed on the front monitor. Each of these views is displayed with a graphical view indicator to visually indicate to the viewer which camera view is being displayed. Note that the view on the remote video monitor may also change according to vehicle control inputs, or may remain on the default view until manually changed by the user. It is significant that the two video monitors may display views independently of each other using the video switch and controller of the preferred embodiments. In the case of a recreational vehicle, the front video monitor may change views according to turn signals, backup light, and brake pedal as described above, while the rear video monitor stays on its default view unaffected by the turn signals, backup light, and brake pedal. Once the vehicle is stopped, the front video monitor may be turned off, and the remote video monitor, which may be in a rear bedroom in the recreational vehicle, may then operate according to alarm and motion sensor inputs from the vehicle. If the alarm goes off, the location of the alarm may be displayed on the remote video monitor. If a motion sensor detects motion, the view from a camera that is pointed to the location where motion was detected may be displayed. Providing independent functions between front and remote monitors gives a level of functionality and flexibility not known in the prior art.

While the invention has been particularly shown and described with reference to preferred embodiments thereof, it will be understood by those skilled in the art that various changes in form and details may be made therein without departing from the spirit and scope of the invention.

I claim:

1. An apparatus comprising:
a first video monitor;
a second video monitor;
a vehicle interface for receiving a plurality of control signals from a vehicle;
a plurality of video cameras that each provide a video output; and
a video switching mechanism coupled to the first video monitor, the second video monitor, the vehicle interface, and the plurality of video cameras, the video switching mechanism comprising:
a first monitor source selector that determines which video output of the plurality of video cameras to display on the first video monitor;
a first default source specification that determines which video output of the plurality of video cameras to display on the first video monitor when no control signals are active on the vehicle interface;
a second monitor source selector that determines which video output of the plurality of video cameras to display on the second video monitor independent of the video output displayed on the first video monitor; and
a second default source specification that determines which video output of the plurality of video cameras to display on the second video monitor.

2. The apparatus of claim 1 further comprising a user interface that allows a user to modify the first default source specification and the second default source specification.

3. The apparatus of claim 1 wherein the first monitor source selector displays on the first video monitor a video output of a video camera disposed to provide a view of the left side of the vehicle in response to a left turn signal on the vehicle being activated on the vehicle interface.

4. The apparatus of claim 1 wherein the first monitor source selector displays on the first video monitor a video output of a video camera disposed to provide a view of the right side of the vehicle in response to a right turn signal on the vehicle being activated on the vehicle interface.

5. The apparatus of claim 1 wherein the first monitor source selector displays on the first video monitor a video output of a video camera disposed to provide a rear view of the vehicle in response to a signal on the vehicle being activated on the vehicle interface that indicates that the vehicle is in reverse.

6. The apparatus of claim 1 wherein the video switching mechanism displays on the first video monitor a graphical view indicator that indicates which video output is currently being displayed on the first video monitor.

7. An apparatus comprising:
a video monitor;
a vehicle interface for receiving a plurality of control signals from a vehicle;
a plurality of video cameras that each provide a video output; and
a video switching mechanism coupled to the video monitor, the vehicle interface, and the plurality of video cameras, the video switching mechanism comprising:
a source selector that determines which video output of the plurality of video cameras to display on the video monitor;
a default source specification that determines which video output of the plurality of video cameras to display on the first monitor when no control signals are active on the vehicle interface; and
a user interface that allows a user to change the default source specification.

8. The apparatus of claim 7 wherein the source selector displays on the video monitor a video output of a video camera disposed to provide a view of the left side of the vehicle in response to a left turn signal on the vehicle being activated on the vehicle interface.

9. The apparatus of claim 7 wherein the source selector displays on the video monitor a video output of a video camera disposed to provide a view of the right side of the vehicle in response to a right turn signal on the vehicle being activated on the vehicle interface.

10. The apparatus of claim 7 wherein the source selector displays on the video monitor a video output of a video camera disposed to provide a rear view of the vehicle in response to a signal on the vehicle being activated on the vehicle interface that indicates that the vehicle is in reverse.

11. The apparatus of claim 7 wherein the video switching mechanism displays on the video monitor a graphical view indicator that indicates which video output is currently being displayed on the video monitor.

12. The apparatus of claim 7 further comprising:
a second video monitor;
wherein the video switching mechanism further comprises:
a second monitor source selector that determines which video output of the plurality of video cameras to display on the second video monitor independent of the video output displayed on the first video monitor; and
a second default source specification that determines which video output of the plurality of video cameras to display on the second video monitor.

13. The apparatus of claim 12 further comprising a user interface that allows a user to change the second monitor source selector to display a different output on the second video monitor independently from the output displayed on the video monitor.

14. An apparatus comprising:
a video monitor;
a vehicle interface for receiving a plurality of control signals from a vehicle;
a plurality of video cameras that each provide a video output; and
a video switching mechanism coupled to the video monitor, the vehicle interface, and the plurality of video cameras, the video switching mechanism comprising:
a source selector that determines which video output of the plurality of video cameras to display on the video monitor; and
a view indicator mechanism that displays a graphical view indicator on the video monitor that indicates which video output is currently being displayed on the video monitor.

15. The apparatus of claim 14 wherein the source selector displays on the video monitor a video output of a video camera disposed to provide a view of the left side of the vehicle in response to a left turn signal on the vehicle being activated on the vehicle interface.

16. The apparatus of claim 14 wherein the source selector displays on the video monitor a video output of a video camera disposed to provide a view of the right side of the vehicle in response to a right turn signal on the vehicle being activated on the vehicle interface.

17. The apparatus of claim 14 wherein the source selector displays on the video monitor a video output of a video camera disposed to provide a rear view of the vehicle in response to a signal on the vehicle being activated on the vehicle interface that indicates that the vehicle is in reverse.

18. The apparatus of claim 14 wherein the video switching mechanism displays on the video monitor a graphical view indicator that indicates which video output is currently being displayed on the video monitor.

19. An apparatus comprising:
a first video monitor mounted in the view of a driver of a vehicle;
a second video monitor mounted in the interior of the vehicle;
a vehicle interface for receiving a plurality of control signals from the vehicle;
a plurality of video cameras coupled to the vehicle that each provide a video output; and
a video switching mechanism coupled to the first video monitor, the second video monitor, the vehicle interface, and the plurality of video cameras, the video switching mechanism comprising:
a first monitor source selector that determines which video output of the plurality of video cameras to display on the first video monitor;
a first default source specification that determines which video output of the plurality of video cameras to display on the first video monitor when no control signals are active on the vehicle interface;
a second monitor source selector that determines which video output of the plurality of video cameras to display on the second video monitor independent of the video output displayed on the first video monitor; and
a second default source specification that determines which video output of the plurality of video cameras to display on the second video monitor;
a user interface that allows a user to modify the first default source specification and the second default source specification;
wherein the first monitor source selector displays on the first video monitor a video output of a video camera disposed to provide a view of the left side of the vehicle in response to a left turn signal on the vehicle being activated on the vehicle interface;
wherein the first monitor source selector displays on the first video monitor a video output of a video camera disposed to provide a view of the right side of the vehicle in response to a right turn signal on the vehicle being activated on the vehicle interface;
wherein the first monitor source selector displays on the first video monitor a video output of a video camera disposed to provide a rear view of the vehicle in response to a signal on the vehicle being activated on the vehicle interface that indicates that the vehicle is in reverse;
wherein the video switching mechanism displays on the first video monitor a graphical view indicator that indicates which video output is currently being displayed on the first video monitor.

20. A method for displaying on a video monitor the outputs of a plurality of video cameras mounted on a vehicle according to control signals received on a vehicle interface, the method comprising the steps of:
providing a first default source specification that determines which output is displayed on the video monitor when no control signals are present on the vehicle interface;
providing a user interface that allows a user to define a second default source specification that determines which output is displayed on the video monitor when no control signals are present on the vehicle interface;
when no control signals are present on the vehicle interface and the user has not specified a default source specification via the user interface, displaying the output determined by the first default source specification; and
when no control signals are present on the vehicle interface and the user has specified a second default source specification via the user interface, displaying the output specified by the second default source specification.

21. The method of claim 20 further comprising the step of displaying on the video monitor a video output of a video camera disposed to provide a view of the left side of the vehicle in response to a left turn signal on the vehicle being activated on the vehicle interface.

22. The method of claim 20 further comprising the step of displaying on the video monitor a video output of a video camera disposed to provide a view of the right side of the vehicle in response to a right turn signal on the vehicle being activated on the vehicle interface.

23. The method of claim 20 further comprising the step of displaying on the video monitor a video output of a video camera disposed to provide a rear view of the vehicle in response to a signal on the vehicle being activated on the vehicle interface that indicates that the vehicle is in reverse.

24. The method of claim 20 further comprising the step of displaying on the video monitor a graphical view indicator that indicates which video output is currently being displayed on the video monitor.

25. A method for displaying on a video monitor the outputs of a plurality of video cameras mounted on a vehicle according to control signals received on a vehicle interface, the method comprising the steps of:
displaying an output of one of the plurality of video cameras on the video monitor; and
displaying a graphical view indicator on the video monitor that indicates which video output is currently being displayed on the video monitor.

26. The method of claim 25 further comprising the step of displaying on the video monitor a video output of a video camera disposed to provide a view of the left side of the vehicle in response to a left turn signal on the vehicle being activated on the vehicle interface.

27. The method of claim 25 further comprising the step of displaying on the video monitor a video output of a video camera disposed to provide a view of the right side of the vehicle in response to a right turn signal on the vehicle being activated on the vehicle interface.

28. The method of claim 25 further comprising the step of displaying on the video monitor a video output of a video camera disposed to provide a rear view of the vehicle in response to a signal on the vehicle being activated on the vehicle interface that indicates that the vehicle is in reverse.

29. A method for displaying on a video monitor in a vehicle the outputs of a plurality of video cameras mounted on the vehicle according to control signals received on a vehicle interface, the method comprising the steps of:
providing a first default source specification that determines which output is displayed on the video monitor when no control signals are present on the vehicle interface;
providing a user interface that allows a user to define a second default source specification that determines which output is displayed on the video monitor when no control signals are present on the vehicle interface;
when no control signals are present on the vehicle interface and the user has not specified a default source specification via the user interface, displaying the output determined by the first default source specification;
when no control signals are present on the vehicle interface and the user has specified a second default source specification via the user interface, displaying the output specified by the second default source specification;
when a left turn signal is active on the vehicle interface, displaying on the video monitor a video output of a video camera disposed to provide a view of the left side of the vehicle;
when a right turn signal is active on the vehicle interface, displaying on the video monitor a video output of a video camera disposed to provide a view of the right side of the vehicle;
when a signal on the vehicle interface that indicates that the vehicle is in reverse is active, displaying on the video monitor a video output of a video camera disposed to provide a rear view of the vehicle;
displaying on the video monitor a graphical view indicator that indicates which video output is currently being displayed on the video monitor; and
displaying on a second video monitor an output of a video camera independently of the display on the video monitor.
